(19) United States
(12) Patent Application Publication
(10) Pub. No.: US 2025/0232612 A1
(43) Pub. Date: Jul. 17, 2025

(54) SYSTEM, METHOD AND COMPUTER PROGRAM PRODUCT FOR USING A BIOMETRIC SENSOR NETWORK TO MEASURE REAL-TIME STUDENT ENGAGEMENT

(71) Applicant: University of Louisville Research Foundation, Inc., Louisville, KY (US)

(72) Inventors: Aly Farag, Louisville, KY (US); Asem Ali, Louisville, KY (US); Islam Alkabbany, Louisville, KY (US)

(21) Appl. No.: 19/024,880

(22) Filed: Jan. 16, 2025

Related U.S. Application Data
(60) Provisional application No. 63/621,383, filed on Jan. 16, 2024.

(51) Int. Cl. G06V 40/16; G06T 7/73; G06V 10/82; G06V 40/20

(52) U.S. Cl. CPC G06V 40/176; G06T 7/73; G06V 10/82; G06V 40/20; G06T 2207/10016; G06T 2207/20084; G06T 2207/30201

(57) ABSTRACT

Described herein are methods, systems and computer program products for measuring student engagement using facial expression analysis by tracking, using a first plurality of video cameras, key facial points of one or more students and using the tracked key facial points extracting a head pose for each of the one or more students; track, using a second plurality of video cameras, eye gaze of each of the one or more students, wherein the head pose and the eye gaze of each of the one or more students is provided to the behavioral engagement module and the emotional engagement module, and wherein the behavioral engagement module classifies an average behavioral engagement of the one or more students and/or a behavioral engagement of each of the one or more students, and wherein the emotional engagement module classifies each students' emotional engagement into two categories, emotionally engaged or emotionally non-engaged.

### CROSS REFERENCE TO RELATED APPLICATION

This application claims priority to and benefit of U.S. Provisional Patent Application Ser. No. 63/621,383 filed Jan. 16, 2024, which is fully incorporated by reference and made a part hereof.

### GOVERNMENT SUPPORT CLAUSE

This invention was made with government support under Grant No. 1900456 awarded by the National Science Foundation (NSF). The government has certain rights in the invention.

### BACKGROUND

The human face is an important tool for nonverbal social communication. Therefore, facial expression analysis is an active research topic for behavioral scientists and has attracted significant attention in the medical image processing community providing broad impact on several applications, such as pain assessment, diagnosis and treatment for autistic children and detecting their emotional patterns, detecting distracted drivers, measuring students' engagement, and human-computer interaction. There were early trials to study facial expressions. In 1862, G. Duchenne electrically stimulated facial muscles and concluded that movement of the muscles around the mouth, nose, and eyes constitute the facial expressions. In 1978 Ekman and Friesen coded these facial movements as a set of Action Units (AUs). Then their system, i.e., Facial Action Coding System (FACS), became the most used method for measuring facial expressions. FIG. 1 Illustrates the human facial muscles that are responsible for different facial expressions. This illustration was designed using images generated by ARTNATOMIA [Anatomical bases of facial expression learning tool, Copyright 2006-2023 Victoria Contreras Flores. SPAIN. Available online: www.artnatomia.net; www.artnatomy.com (accessed on 2 Sep. 2017)].

Despite the urgent demand for graduates from science, technology, engineering, and mathematics (STEM) disciplines, large numbers of U.S. university students drop out of engineering majors. Nearly one-half of students fail to complete an engineering program at large, public institutions. This number is even higher for at-risk women, racial and ethnic minorities, and first-generation college students. The greatest dropout from engineering occurs in early engineering courses of high mathematical content (e.g., introductory calculus, probability, circuit/network analysis, and signals & systems). Students often retain and apply only a surface-level knowledge of mathematics, physics and chemistry. In addition, socio-psychological factors, such as perceptions of social belonging, motivation, and test anxiety, predict first-year retention.

The ability to measure students' engagement in an educational setting may improve their retention and academic success. This ability may reveal disinterested students or which segments of a lesson cause difficulties.

Currently, feedback on student performance relies almost exclusively on graded assignments, with in-class behavioral observation by the instructor as a distant second. In-class observation of engagement by the instructor is problematic because he/she is primarily occupied with delivering the learning material. Indeed, modern learning environments allow free-form seating, and the instructor may not be able to have direct eye contact with the students. Even in traditional classroom seating, an instructor would not be able to observe a large number of students while lecturing. Therefore, it is practically impossible for the instructor to watch all students all the time while recording these observations student by student and correlating them with the associated material and delivery method. Moreover, these types of feedback are linked to the in-class environment. In an e-learning environment, the instructor may lose any feedback to sense student engagement. Performance on assignments can also be ambiguous. Some students can be deeply engaged yet struggling, whereas other students can be only minimally engaged; both groups end up with poor performance. Other students may manage good performance while lacking a deeper understanding of the material, e.g., merely studying to memorize an exam without engagement in the learning process.

The education research community has developed various taxonomies describing student engagement. After analyzing many studies, Fredricks et al. [Fredricks, J. A.; Blumenfeld, P. C.; Paris, A. H. School engagement: Potential of the concept, state of the evidence. Rev. Educ. Res. 2004, 74, 59-109, incorporated by reference] organized engagement into three categories. Behavioral engagement includes external behaviors that reflect internal attention and focus. It can be operationalized by body movement, hand gestures, and eye movement. Emotional engagement is broadly defined as how students feel about their learning, learning environment, teachers, and classmates. Operationalization of emotional engagement includes expressing interest, enjoyment, and excitement, all of which can be captured by facial expressions. Cognitive engagement is the extent to which the student is mentally processing the information, making connections with prior learning, and actively seeking to make sense of the key instructional ideas. The two former engagement categories can be easily sensed and measured. Cognitive engagement is generally less well-defined than the other two modes of engagement and is more difficult to externally operationalize due to its internalized nature. The three components (shown in FIG. 2 and further described in Table 1, below) that comprise student engagement are behavior, emotion, and cognition. These components work together to fully encompass the student engagement construct, and each component has been found to contribute to positive academic outcomes.

TABLE 1
Psychological Constructs for the Three Types of Engagement.

| TYPE OF | COGNITIVE | BEHAVIORAL | EMOTIONAL |
|---|---|---|---|
| ENGAGMENT | (C) | (B) | (E) |
| Psychological | Levels of | Targets of | Affective |
| Construct | processing | attention [3] | context [4] |
| | [1, 2] | | |
| Engaged State | Deep | On-task attention | Positive affect |
| | processing | | |
| Disengaged State | Shallow | Off-task attention | Negative affect |
| | processing | | |
| External | Not directly | Eye gaze, head | Facial Action |
| Operationalization | observable | pose, etc. | Coding System |

One of the significant obstacles to assessing the effect of engagement in student learning is the difficulty of obtaining a reliable measurement of engagement. Using biometric sensors (such as cameras, microphones, heart rate wristbands sensors, and EEG devices) provides a more dynamic and objective approach for sensing.

Therefore, what are needed are systems, methods and computer program products that overcome challenges in the art, some of which are described above. Specifically, what is desired is a system, method and computer program product that provides instructors with a tool that could help them in estimating both the average class engagement level and the individuals' engagement levels while they give lectures in real-time. Such a system could help the instructors to take actions to improve students' engagement. Additionally, it could be used by the instructor to tailor the presentation of material in class, identify course material that engages and disengages with students, and identify students who are engaged or disengaged and at risk of failure.

### SUMMARY

Described herein are embodiments of systems, methods, and computer program products for utilizing facial expression analysis to measure student engagement using a biometric sensor network and technologies for modeling and validating engagement in various class setups.

One aspect described and disclosed herein are embodiments of systems, methods and computer program products for measuring student engagement level using facial information for an e-learning environment and/or the in-class environment. Estimating engagement level in the in-class environment is more complicated because rather than the presence of only one target of interest (laptop screen) in the case of e-learning, there are multiple targets of interest in the in-class environment. The student may look at the instructor, the whiteboard, the projector, his/her laptop screen, or even one of his/her peers. Therefore, the disclosed framework tracks where each student's gaze is and relates them together to estimate the students' behavioral engagement.

A number of different technologies were used to capture student's engagement in classrooms, e.g., i) audience response systems (e.g., [5-12]); ii) wristband: (e.g., Affectiva's [13]); iii) camera-based system capturing facial and body cues (e.g., [14-26]); and iv) sensor-suite: (e.g., EduSense [27].) Attempts to measure proxies for engagement using different sensors, include multimedia [28-34], heart rate [35], electrodermal activity [36-37], and neurobehavioral markers [38]. The technology described herein is based on video sensors embedded with a smart computing unit that is flexible for use and does not add any burden on students' own computers, in addition to flexibility in networking. The technology is non-invasive, non-intrusive, non-stigmatizing, scalable and inexpensive deployable system for in-class and real-time measurement of emotional and behavioral engagement.

It should be understood that the above-described subject matter may also be implemented as a computer-controlled apparatus, a computing system, or an article of manufacture, such as a computer program product stored on a non-transient computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 illustrates the human facial muscles that are responsible for different expressions.

FIG. 2 illustrates a conceptual framework linking on-task/off-task behavioral, positive/negative emotions, and deep/shallow cognitive engagement.

FIG. 3 is an illustration of an overview of an exemplary framework for determining behavioral engagement.

FIG. 4 is an illustration of an overview of an exemplary framework for determining emotional engagement.

FIG. 5A illustrates that in the presence of pose, the uniform grid suffers from a lack of correspondences (red and blue (darkened) rectangles) due to displacement and occlusion.

FIG. 5B illustrates that to minimize the lack of correspondence shown in FIG. 5A, facial landmarks are used to define a sparse set of patches.

FIG. 6 illustrates an exemplary student hardware module.

FIG. 7 illustrates an example of a biometric sensor network that can be used in aspects of the invention.

FIG. 8 illustrates an example of an instructor dashboard that summarizes class students' engagement in a clear and simplified way.

FIG. 9 illustrates a set of tokens that were defined by education experts and used to annotate facial video data.

FIG. 10 illustrates example graphs of the engagement level of 10 students during a lecture.

FIG. 11A illustrates the behavioral engagement confusion matrix.

FIG. 11B illustrated the emotional engagement confusion matrix.

FIG. 12 is a block diagram of an example computing device upon which embodiments of the invention may be implemented.

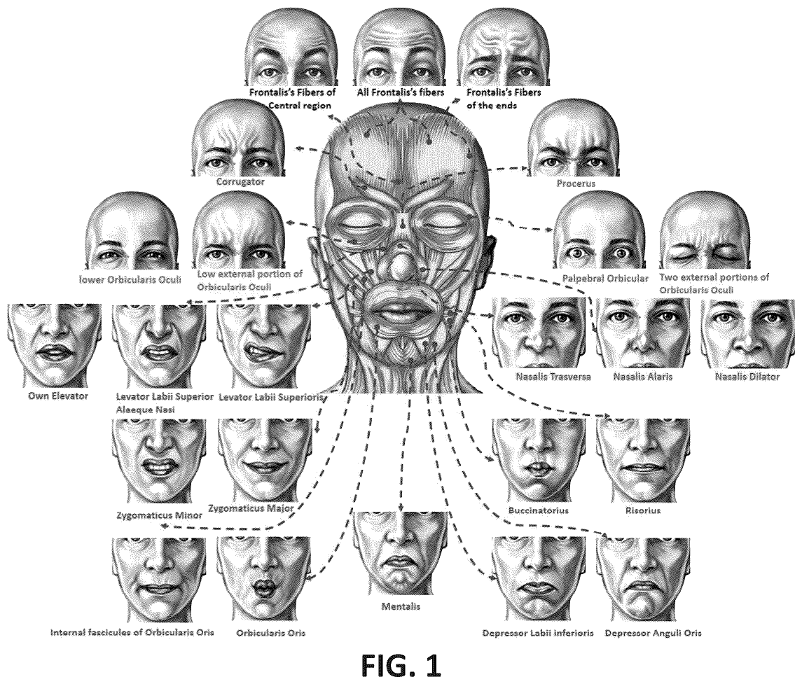

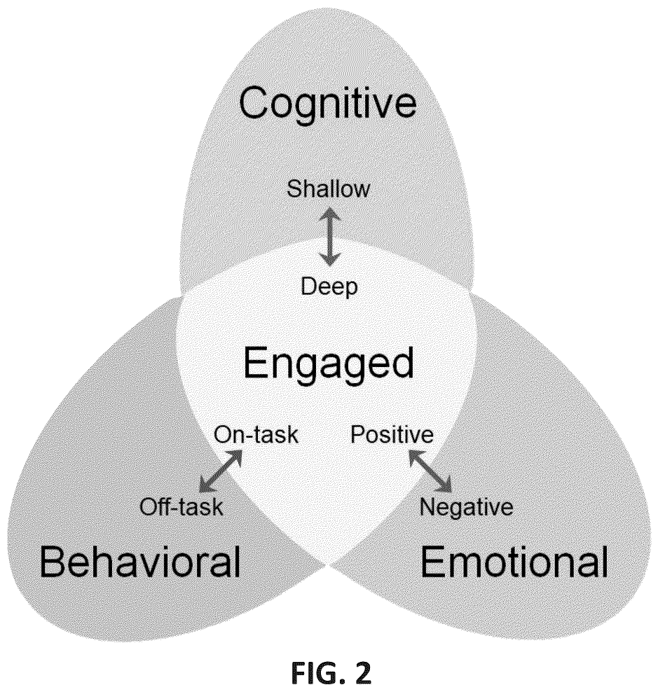

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure.

As used in the specification and the appended claims, the singular forms “a,” “an,” “the,” and “data” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Furthermore, as used herein, the terms “word” or “words” includes a complete word, only a portion of a word, or a word segment.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

Disclosed herein is a system, method and computer-program product that utilizes facial expression analysis to measure student engagement using a biometric sensor network and technologies for modeling and validating engagement in various class setups.

Behavioral engagement comprises the actions that students take to gain access to the curriculum. These actions include self-directive behaviors outside of class, such as doing homework and studying; and other activities are related, such as shifting in the seat, hand movements, body movements, or other subs/conscious movements while observing lectures. Finally, one can participate cooperatively in in-class activities.

Head pose and eye gaze are some of the metrics with which to measure the student's behavioral engagement. By estimating the student's point of gaze, it can be estimated whether he/she is engaged with the lecture. If the student is looking at his/her laptop or lecture notes, the whiteboard, the projector screen, or the lecturer, he/she is probably highly behaviorally engaged. If a student looks at other things, he/she is probably not engaged. In the disclosed system, distracted and uninterested students are identified by a low behavioral engagement level regardless of the reason for this distraction. For a regular class setting with an assumption that students are in good health, this distraction is related to class content. On the other hand, a student's illness can be detected by measuring the student's vital signs using a wristband. Additionally, a student's fatigue can be identified using his or her emotions. Moreover, other abnormalities, such as eye problems and nick movement problem, can be identified by the instructor at the beginning of the class. All these types of disengagement should not be included in class content evaluation.

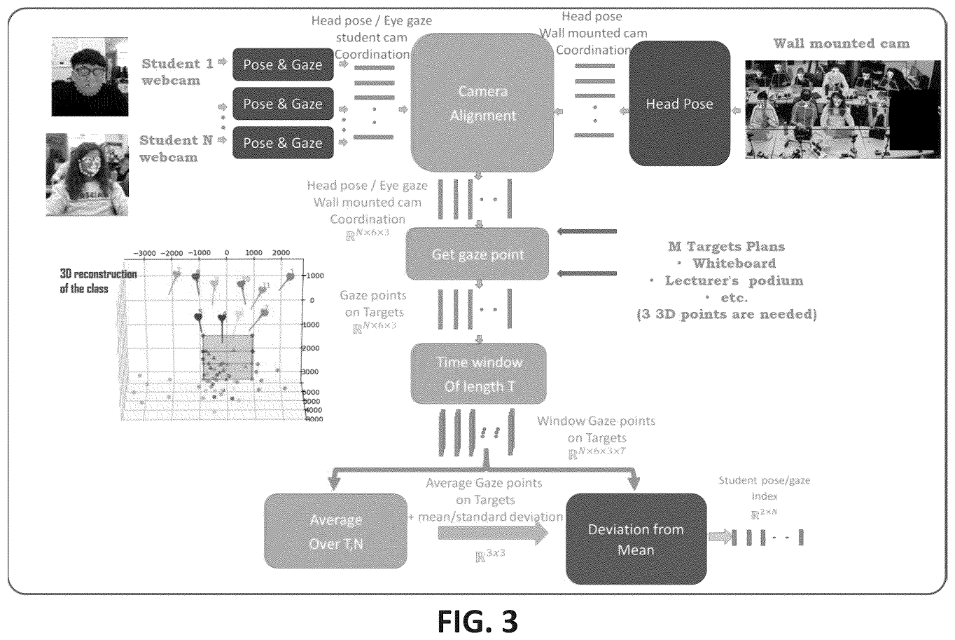

In one example of the disclosed framework, two sources of video streams are used. The first source is a wall-mount camera that captured the whole class, and the second source is the dedicated webcam in front of each student. The proposed pipeline is shown in FIG. 3.

The first step in the exemplary framework is tracking key facial points and using them to extract the head pose. In one instance, this process takes advantage of using a convolutional experts-constrained local model (CE-CLM), which uses a 3D representation of facial landmarks and projects them on the image using orthographic camera projection. This allows the framework to estimate the head pose accurately once the landmarks are detected. The resulting head pose could be represented in six degrees of freedom (DOF) (three degrees of freedom of head rotation (R)—yaw, pitch, and roll—and 3 degrees of translation (T)—X, Y, and Z). Eye gaze tracking is the process of measuring either the point of gaze or the motion of an eye relative to the head. The eye gaze could be represented as the vector from the 3D eyeball's center to the pupil. In order to estimate the eye gaze using this approach, the eyelids, iris, and pupil are detected using the method described in [Wood, E.; Baltrusaitis, T.; Zhang, X.; Sugano, Y.; Robinson, P.; Bulling, A. Rendering of eyes for eye-shape registration and gaze estimation. In Proceedings of the IEEE International Conference on Computer Vision, Santiago, Chile, 7-13 Dec. 2015; pp. 3756-3764, which is fully incorporated by reference.]. The detected pupil and eye location are used to compute the eye gaze vector for each eye. A vector from the camera origin to the center of the pupil in the image plane is drawn, and its intersection with the eye-ball sphere is calculated to get the 3D pupil location in world coordinates.

The wall-mounted camera provides the head pose only, as the face size may be too small to get accurate eye gaze from it, and the students' cameras provide both head poses and eye gazes. Each camera provides the output in its world coordinates. Therefore, the second step is to align all the camera's coordinates to get all students' head poses and eye gazes in a common world-coordinate system. Given a well-known class setup, the target planes could be found through one-time pre-calibration for the class. The intersections of the students' head pose/eye gaze rays and the target planes are calculated. To eliminate noise, the feature may be combined within a window of time of size T. Then, the mean point of gaze can be found on each plane in addition to the standard deviation for each window of time. The plane of interest in each window of time is the one with the least standard deviation of the students' gaze. For each student, the student's pose/gaze index can be calculated as the deviation of student's gaze points from the mean gaze point in each window if time. This index is used to classify the average behavioral engagement within a window of time.

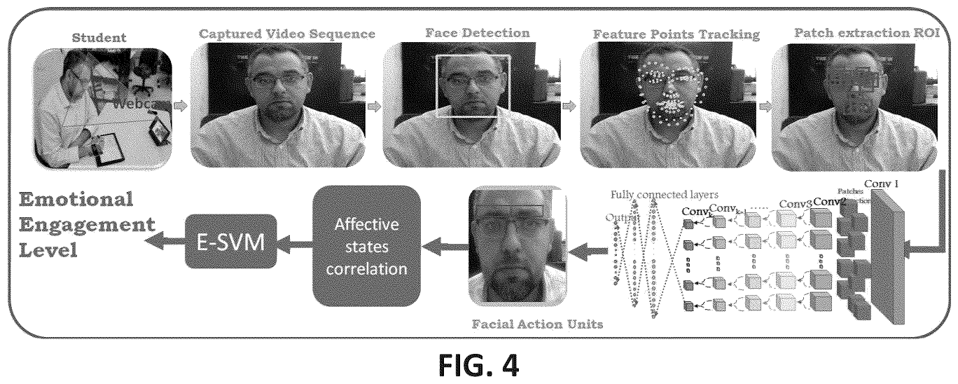

Emotional engagement is broadly defined as how students feel about their learning, learning environment, and instructors and classmates. Emotions include happiness or excitement about learning, boredom or disinterest in the material, and frustration due a struggle to understand. Disclosed herein is a framework for the automatic measurement of the emotional engagement level of students in an in-class environment. The disclosed framework captures the video of the user using a regular webcam; it tracks their faces throughout the video's frames. Different features are extracted from the user's face—e.g., facial landmark points and facial action units—as shown in FIG. 4.

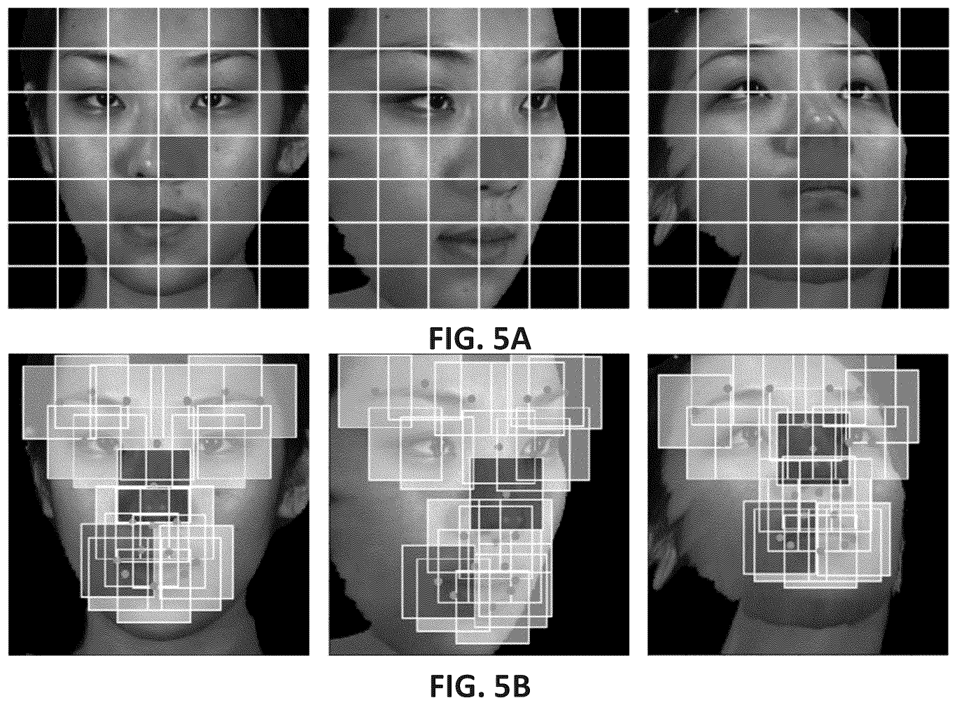

It is logical to assume that a low measure of attentiveness indicated by the behavioral engagement component will not be enhanced by the emotional engagement classifier. Therefore, the application of the emotional engagement classifier is predicated on evidence of behavioral engagement in overall engagement estimation. To measure emotional engagement, the proposed module uses the extracted faces from previous steps to extract 68 facial feature points using an approach presented in [Mostafa, E.; Ali, A. A.; Shalaby, A.; Farag, A. A Facial Features Detector Integrating Holistic Facial Information and Part-Based Model. In Proceedings of the CVPR-Workshops, Boston, MA, USA, 7-12 Jun. 2015, which is fully incorporated by reference]. This approach's performance depends on a well-trained model. The current model was trained on the multiview faces 300 Faces In-the-Wild database [Sagonas, C.; Antonakos, E.; Tzimiropoulos, G.; Zafeiriou, S.; Pantic, M. 300 Faces In-The-Wild Challenge: Database and results. Image Vis. Comput. 2016, 47, 3-18, incorporated by reference.], which has faces with multi-PIE (pose, illumination, and expression); therefore, the model performs well on different poses. Such a model allows the framework to estimate students' engagement even if their faces are not front-facing. This helps student to sit freely on their seats without restrictions. Next, it uses a method for action-unit detection under pose variation [Ali, A. M.; Alkabbany, I.; Farag, A.; Bennett, I.; Farag, A. Facial Action Units Detection Under Pose Variations Using Deep Regions Learning. In Proceedings of the Seventh International Conference on Affective Computing and Intelligent Interaction (ACII), San Antonio, TX, USA, 23-26 Oct. 2017, incorporated by reference]. It uses the detected facial points to extract the most significant 22 patches to be used for the action-unit detection. This action unit (AU) detection technique exploits both the sparse nature of the dominant AUs regions and semantic relationships among AUs. To handle pose variations, this algorithm defines patches around facial landmarks instead of using a uniform grid, which suffers from displacement and occlusion problems; see FIG. 5. Then, it used a deep region-based neural network architecture in a multi-label setting to learn both the required features and the semantic relationships of AUs. Moreover, the weighted loss function is used to overcome the imbalance problem in multi-label learning. Then, the extracted facial action units are used to estimate the affective states (boredom, confusion, delight, frustration, and neutral) by correlations using McDaniel et al.'s method [McDaniel, B.; D'Mello, S.; King, B.; Chipman, P.; Tapp, K.; Graesser, A. Facial features for affective state detection in learning environments. In Proceedings of the Annual Meeting of the Cognitive Science Society, Nashville, TN, USA, 1-4 Aug. 2007; Volume 29, incorporated by reference]. This method determines the extent to which each of the facial features is used to feed a support vector machine (SVM) to classify the students' emotional engagement into two categories, emotionally engaged or emotionally non-engaged.

### EXPERIMENTAL RESULTS

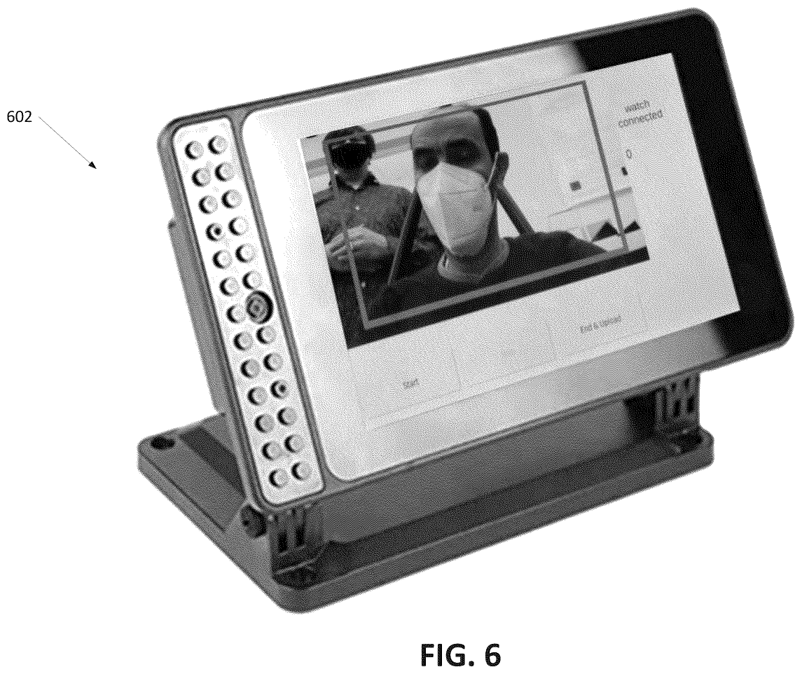

Using student webcams and machines to run the proposed client module raises many issues, especially with the huge variety that students have in terms of hardware and software. The camera quality cannot be guaranteed, and multiple versions of the software are needed to ensure that it runs on each operating system. Additionally, the student may fold his/her laptop and use it to take notes, which leads to the impossibility of capturing the student's face. Therefore, a special hardware unit 602 was designed and installed in the classroom to be used as a client module to capture students' faces. One embodiment of this student hardware module 602 is comprised of a Raspberry Pi microcontroller connected to a webcam and a touch display; see FIG. 6, though other devices, hardware and/or software are considered to be within the scope of this disclosure. The Raspberry Pi micro-controller runs a program that connects to the server 702, captures the video stream, applies the introduced pipelines to extract the feature vector, and sends that vector to the server 702. The program allows the students to adjust the webcam to ensure that the video has a good perspective of the face. This student hardware module 602 is also used in the data collection phase. It captures a video stream of the student's face during the lecture and processes it in real-time to obtain the required metric and send the features to a server/high-performance computing machine 702. The Raspberry Pi uses encryption (e.g., a TLS-encrypted connection) to ensure students' data security and privacy.

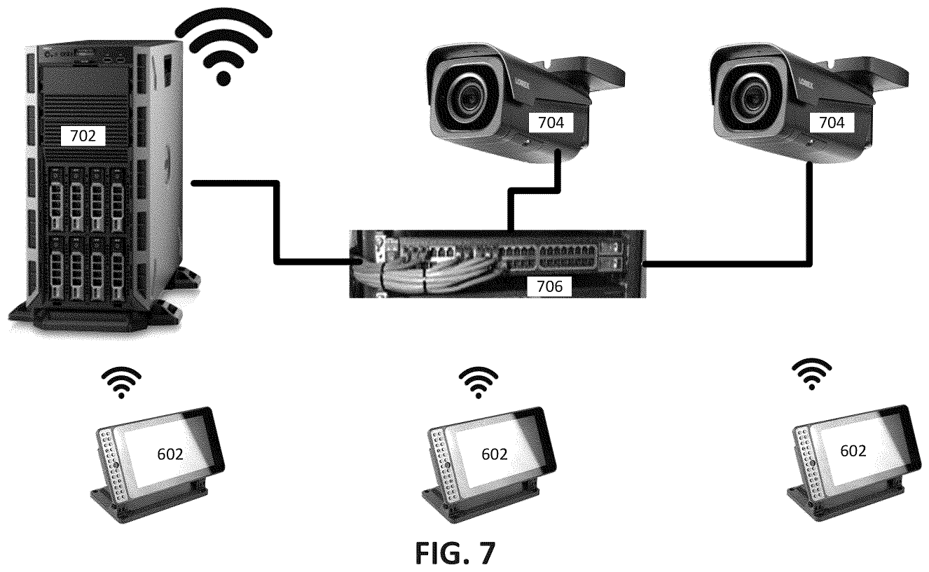

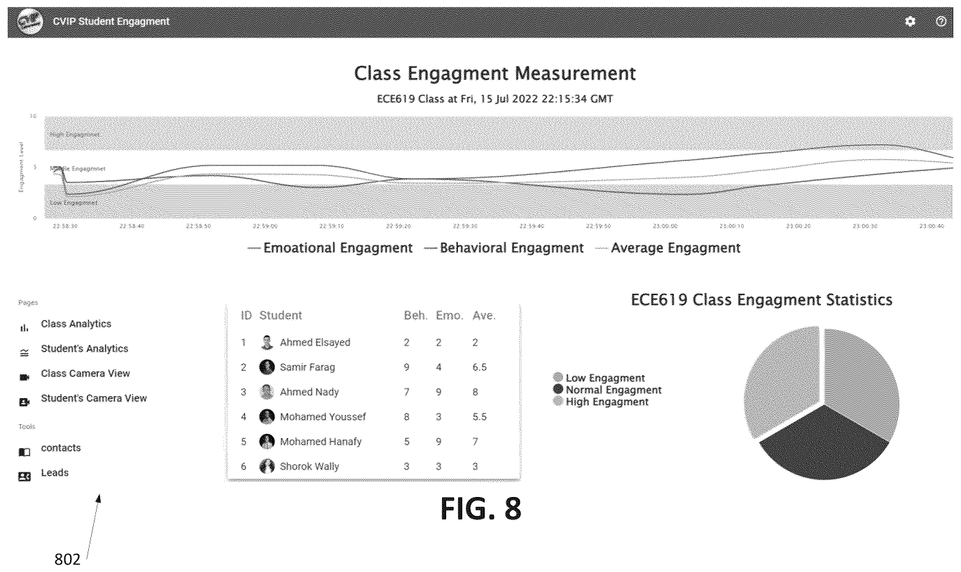

The server 702 is a high-performance computing machine that collects all the streams/features and classifies the engagement level in real time. The setup also includes one or more high-definition (e.g., 4K) wall-mounted cameras 704 to capture a stream of students' faces to get their head poses. Additionally, the configuration provides high-bandwidth network equipment 706 for both wire and wireless connections, see FIG. 7. The server 702 also provides the instructor with a web-based dashboard 802, such as the exemplary one shown in FIG. 8, which allows the instructor to monitor the average class engagement level or the individual's levels. The instructor can monitor the dashboard 802 on a separate screen without obstructing the dynamics of the class. The dashboard 802 gives the instructor the average of class engagement in real-time. Thus, regardless of the class size, the dashboard 802 is compact and has a simple illustration. In addition, more individual analysis can be shown offline after the class, if needed.

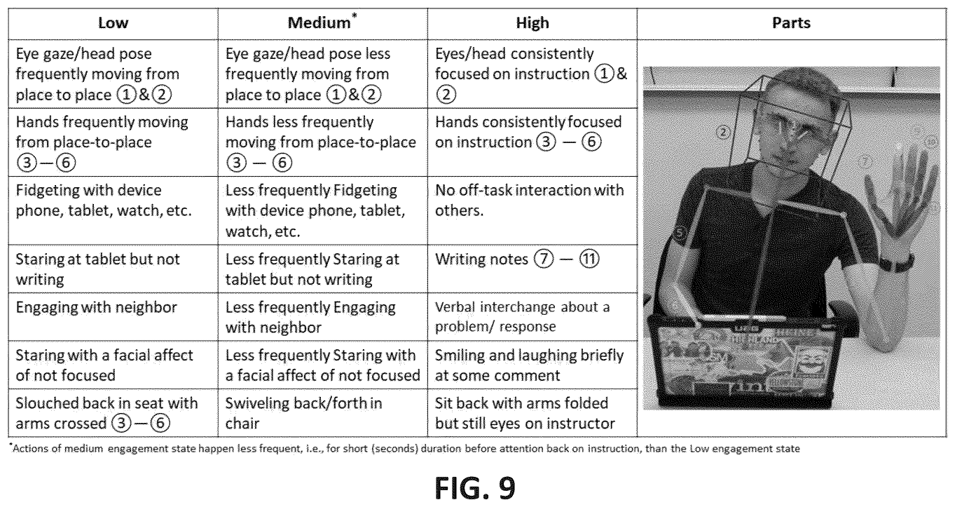

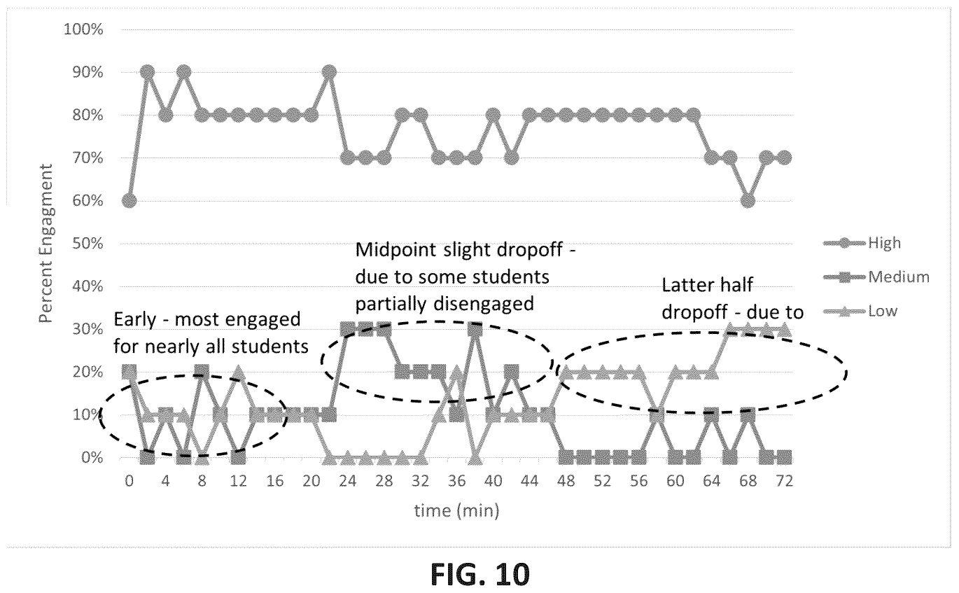

The hardware and software described in relation to FIGS. 6, 7 and 8 was used to capture subjects' facial videos while attending four lectures. The facial videos were recorded during the lectures. The collected dataset comprises 10 students of 300-level stem classes. These data were annotated by professorial educators. Each lecture is 75 min in length and was divided into 2-min windows, which resulted in 1360 samples. These data were annotated by education experts. Three engagement levels were defined using a set of tokens, which are summarized in FIG. 9. A sample of the annotation during a lecture is shown in FIG. 10. As shown in FIG. 10, at the beginning of the lecture, most students were engaged. In the middle of the lecture, students' engagement dropped somewhat due to some students partially disengaging. Later, at the end of the lecture, half dropped off, due to some students mostly disengaging. These results provide strong evidence for common observable behaviors and/or emotions that reflect student engagement.

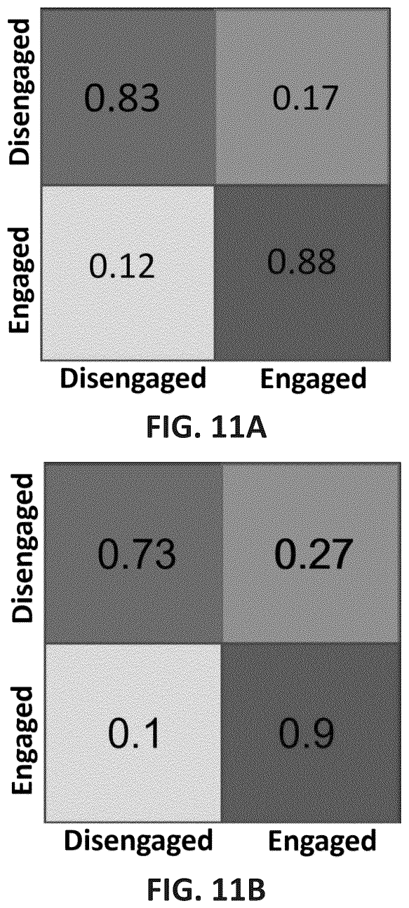

A high-performance computing machine could run the proposed framework at a high frame rate of 10-15 fps, depending on the number of students in class. Raspberry Pi micro-controllers are able to run the proposed framework and process video stream to extract the individual students' features (Head pose, Eye gaze, Action units) with a rate of 2-3 frames per second. Within a 2 min time window, we can get 240 processed feature vectors. The collected dataset was used to train support vector machine (SVM) classifiers to classify the engagement components (the behavioral and emotional engagement). The leave-one-out cross-validation technique was used for evaluation. The result-agreement ratios for the disengaged and engaged in terms of behavioral engagement were 83% and 88%, respectively. The agreement ratios for the disengaged and engaged in terms of emotional engagement were 73% and 90%, respectively. FIGS. 11A and 11B show the confusion matrices of the proposed behavioral and emotional engagement classification.

It is to be appreciated that the above described steps can be performed by computer-readable instructions executed by a processor or one or more processors. As used herein, a processor is a physical, tangible device used to execute computer-readable instructions. Furthermore, “processor,” as used herein, may be used to refer to a single processor, or it may be used to refer to one or more processors.

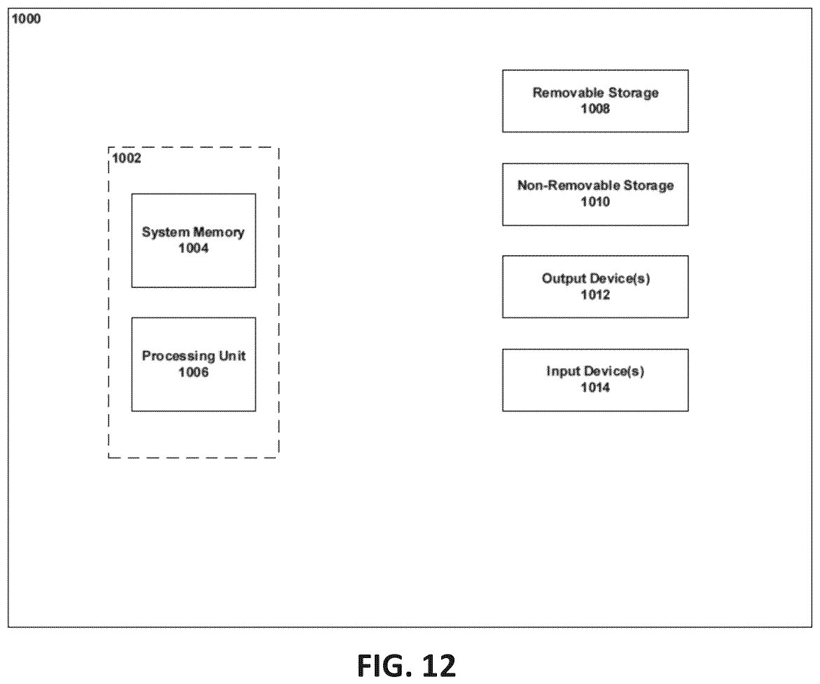

When the logical operations described herein are implemented in software, the process may be executed on any type of computing architecture or platform. For example, referring to FIG. 12, an example computing device upon which embodiments of the invention may be implemented is illustrated. In particular, at least one processing device described above may be a computing device, such as computing device 1000 shown in FIG. 12. For example, computing device 1000 may be all or a component of a cloud computing and storage system. Computing device 1000 may comprise all or a portion of the server 702 and/or the student hardware module 602. The computing device 1000 may include a bus or other communication mechanism for communicating information among various components of the computing device 1000. In its most basic configuration, computing device 1000 typically includes at least one processing unit 1006 and system memory 1004. Depending on the exact configuration and type of computing device, system memory 1004 may be volatile (such as random access memory (RAM)), non-volatile (such as read-only memory (ROM), flash memory, etc.), or some combination of the two. This most basic configuration is illustrated in FIG. 12 by dashed line 1002. The processing unit 1006 may be a standard programmable processor that performs arithmetic and logic operations necessary for operation of the computing device 1000.

Computing device 1000 may have additional features/functionality. For example, computing device 1000 may include additional storage such as removable storage 1008 and non-removable storage 1010 including, but not limited to, magnetic or optical disks or tapes. Computing device 1000 may also contain network connection(s) that allow the device to communicate with other devices. Computing device 1000 may also have input device(s) 1014 such as a keyboard, mouse, touch screen, scanner, etc. Output device(s) 1012 such as a display, speakers, printer, etc. may also be included. The additional devices may be connected to the bus in order to facilitate communication of data among the components of the computing device 1000. All these devices are well known in the art and need not be discussed at length here. Network connection(s) may include one or more interfaces. The interface may include one or more components configured to transmit and receive data via a communication network, such as the Internet, Ethernet, a local area network, a wide-area network, a workstation peer-to-peer network, a direct link network, a wireless network, or any other suitable communication platform. For example, interface may include one or more modulators, demodulators, multiplexers, demultiplexers, network communication devices, wireless devices, antennas, modems, and any other type of device configured to enable data communication via a communication network. Interface may also allow the computing device to connect with and communicate with an input or an output peripheral device such as a scanner, printer, and the like.

The processing unit 1006 may be configured to execute program code encoded in tangible, non-transitory computer-readable media. Computer-readable media refers to any media that is capable of providing data that causes the computing device 1000 (i.e., a machine) to operate in a particular fashion. Various computer-readable media may be utilized to provide instructions to the processing unit 1006 for execution. Common forms of computer-readable media include, for example, magnetic media, optical media, physical media, memory chips or cartridges, a carrier wave, or any other medium from which a computer can read. Example computer-readable media may include, but is not limited to, volatile media, non-volatile media and transmission media. Volatile and non-volatile media may be implemented in any method or technology for storage of information such as computer readable instructions, data structures, program modules or other data and common forms are discussed in detail below. Transmission media may include coaxial cables, copper wires and/or fiber optic cables, as well as acoustic or light waves, such as those generated during radio-wave and infra-red data communication. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 1006 may execute program code stored in the system memory 1004. For example, the bus may carry data to the system memory 1004, from which the processing unit 1006 receives and executes instructions. The data received by the system memory 1004 may optionally be stored on the removable storage 1008 or the non-removable storage 1010 before or after execution by the processing unit 1006.

Computing device 1000 typically includes a variety of computer-readable media. Computer-readable media can be any available media that can be accessed by device 1000 and includes both volatile and non-volatile media, removable and non-removable media. Computer storage media include volatile and non-volatile, and removable and non-removable media implemented in any method or technology for storage of information such as computer readable instructions, data structures, program modules or other data. System memory 1004, removable storage 1008, and non-removable storage 1010 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1000. Any such computer storage media may be part of computing device 1000.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

### CONCLUSION

Disclosed and described herein is a framework for automatically measuring the student's behavioral and emotional engagement levels in the class environment. This framework provides instructors with real-time estimation for both the average class engagement level and the engagement level of each individual, which will help the instructor make decisions and plans for the lectures, especially in large-scale classes or in settings in which the instructor cannot have direct eye contact with the students.

The streams from high-definition cameras are used to capture students' bodies, then extract their body poses and body actions. These actions allow the behavioral module to classify the students' behavioral engagement. Additionally, to enhance emotional engagement, additional features such as heart rate variability (HRV) and galvanic skin response (GSK) may be monitored and provided to the server 702.

As more data is collected for more students who attend multiple courses during the entire semester, it can be used for training and evaluating both behavioral and emotional engagement measurement modules. It will also allow the emotional engagement measurement module to become more complicated by classifying chunks of video (time window) rather than individual frames.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications may be referenced. The disclosures of these publications in their entireties are hereby incorporated by reference into this application in order to more fully describe the state of the art to which the methods and systems pertain. Specifically incorporated by reference and made a part hereof is, Alkabbany, I.; Ali, A. M.; Foreman, C.; Tretter, T.; Hindy, N.; Farag, A. An Experimental Platform for Real-Time Students Engagement Measurements from Video in STEM Classrooms. Sensors 2023, 23, 1614. https://doi.org/10.3390/s23031614. Further incorporated by reference and made a part hereof are the following references:

### REFERENCES

[1] F. I. Craik and R. S. Lockhart, “Levels of processing: A framework for memory research,” Journal of verbal learning and verbal behavior, vol. 11, no. 6, pp. 671-684, 1972.
[2] F. Marton and R. Säljö, “On qualitative differences in learning: I—Outcome and process,” British journal of educational psychology, vol. 46, no. 1, pp. 4-11, 1976.
[3] M. I. Posner and S. E. Petersen, “The attention system of the human brain,” Annual Review of Neuroscience, vol. 13, no. 1, pp. 25-42, 1990.
[4] D. Watson, D. Wiese, J. Vaidya, and A. Tellegen, “The two general activation systems of affect: Structural findings, evolutionary considerations, and psychobiological evidence,” Journal of Personality and Social Psychology, vol. 76, no. 5, p. 820, 1999.
[5] J. E. Gain, “Using poll sheets and computer vision as an inexpensive alternative to clickers,” in In Proceedings of the South African Institute for Computer Scientists and Information Technologists Conference (SAICSIT '13), New York, 2013.
[6] A. Cross, C. E., and W. Thies, “Low-cost audience polling using computer vision,” in In Proceedings of the 25th annual ACM symposium on User interface software and technology (UIST '12), New York, 2012.
[7] M. Miura and T. Nakada, “Device-Free Personal Response System Based on Fiducial Markers,” in In Proceedings of the 2012 IEEE Seventh International Conference on Wireless, Mobile and Ubiquitous Technology in Education (WMUTE '12), Washington, 2012.
[8] A. L. Abrahamson, “An Overview of Teaching and Learning Research with Classroom Communication Systems,” in International Conference on Teaching of Mathematics, Samos, Greece, 1998.
[9] J. E. Caldwell, “Clickers in the large classroom: current research and best-practice tips,” CBE—Life Sciences Education, vol. 6, no. 1, pp. 9-20, 2007.
[10] S. Draper, J. Cargill, and Q. Cutts, “Electronically Enhanced Classroom Interaction,” Australian Journal of Educational Technology, pp. 13-23, 2002.
[11] C. Fies and N. Jill, “Classroom Responses Systems: A Review of the Literature,” Journal of Science Education and Technology, pp. 101-109, 2006.
[12] S. Robbins, “Beyond clickers: using ClassQue for multidimensional electronic classroom interaction,” in In Proceedings of the 42nd ACM technical symposium on Computer science education (SIGCSE '11), New York, 2011.
[13] R. W. Picard, “Measuring affect in the wild,” in In Proc. of International Conference on Affective Computing and Intelligent Interaction, Berlin, 2011.
[14] A. Kapoor and R. Picard. (2005) Multimodal affect recognition in learning environments. Annual ACM international conference on Multimedia. 677-682.
[15] B. McDaniel, S. D'Mello, B. King, P. Chipman, K. Tapp, and A. Graesser. (2007) Facial features for affective state detection in learning environments. the 29th Annual Cognitive Science Society. 467-472.
[16] S. D'Mello and A. Graesser, “Multimodal semi-automated affect detection from conversational cues, gross body language, and facial features,” User Modeling and User-Adapted Interaction, vol. 20, no. 2, pp. 147-187, 2010.
[17] J. F. Grafsgaard, J. B. Wiggins, K. E. Boyer, E. N. Wiebe, and J. C. Lester, “Automatically recognizing facial expression: Predicting engagement and frustration,” in In Proceedings of the 6th International Conference on Educational Data Mining, 2013.
[18] J. Whitehill, Z. Serpell, Y.-C. Lin, A. Foster, and J. R. Movellan, “The faces of engagement: Automatic recognition of student engagement from facial expressions,” IEEE Transactions on Affective Computing, vol. 5, no. 1, pp. 86-98, 2014.
[19] M. Raca and P. Dillenbourg, “System for assessing classroom attention,” in In Proceedings of the Third International Conference on Learning Analytics and Knowledge (LAK '13), New York, 2013.
[20] R. Stiefelhagen, “Tracking Focus of Attention in Meetings,” in In Proceedings of the 4th IEEE International Conference on Multimodal Interfaces (ICMI '02), Washington, 2002.
[21] J. Zaletelj and A. Košir, “Predicting students' attention in the classroom from Kinect facial and body features,” EURASIP Journal on Image and Video Processing, vol. 1, 2017.
[22] N. Bosch, C. Y., and S. D'Mello, “It's written on your face: detecting affective states from facial expressions while learning,” in In Proceedings of the 12th International Conference on Intelligent Tutoring Systems (ITS 2014), Switzerland, 2014.
[23] A. Kapoor, W. Burleson, and R. W. Picard, “Automatic prediction of frustration,” International Journal of Human-Computer Studies, vol. 65, no. 8, pp. 724-736, 2007.
[24] N. Bosch, S. K. D'Mello, J. Ocumpaugh, R. S. Baker, and V. Shute, “Using Video to Automatically Detect Learner Affect in Computer-Enabled Classrooms,” in In Proc. of ACM Trans. Interact. Intell. Syst., 2016.
[25] R. Beckwith, G. Theocharous, D. Avrahami, and M. Philipose, “ESP: Everyday Sensing and Perception in the Classroom,” Intel® Technology Journal, vol. 14, no. 1, pp. 18-33, 2010.
[26] N. Yannier, K. Koedinger, and S. Hudson, “Tangible Collaborative Learning with a Mixed-Reality Game: EarthShake,” in Artificial Intelligence in Education, 2013.
[27] K. Ahuja et al., “EduSense: Practical Classroom Sensing at Scale,” in Proc. ACM Interact. Mob. Wearable Ubiquitous Technol., 2019.
[28] N. a. 1842220, “Computer-Assisted Video Analysis Methods for Understanding Underrepresented Student Participation and Learning in Collaborative Learning Environments.”
[29] N. a. 1561182, “Collaborative Research: Cognitive Mechanisms of Early Math Learning—Improving Outcomes by Harnessing Multiple Memory Representations.”
[30] N. a. 1735793, “EXP:Collaborative Research:Cyber-enabled Teacher Discourse Analytics to Empower Teacher Learning.”
[31] N. a. 1822768, “Teachers are the Learners: Providing Automated Feedback on Classroom Inter-Personal Dynamics.”
[32] N. a. 1920796, “Advancing Computational Grounded Theory for Audiovisual Data from STEM Classrooms.”
[33] N. a. 2000487, “Using Neural Networks for Automated Classification of Elementary Mathematics Instructional Activities.”
[34] N. a. 2016993, “Investigating the Role of Interest in Middle Grade Science with a Multimodal Affect-Sensitive Learning Environment.”
[35] N. a. 1561728, “Learning from Online Lectures in STEM: Using Multimedia Principles and Fostering Social Agency with Transparent Whiteboards.”
[36] N. a. 1661100, “Collaborative Research: EHR Core: Exploring the Emotional and Motivational Lives of Undergraduate Engineering Students.”
[37] N. a. 1916417, “MetaDash: A Teacher Dashboard Informed by Real-Time Multichannel Self-Regulated Learning Data.”
[38] N. a. 1920510, “Modeling Brain and Behavior to Uncover the Eye-Brain-Mind Link during Complex Learning.”

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed:

1. A system for measuring student engagement using facial expression analysis, said system comprising:
a server, said server comprising at least a behavioral engagement module and an emotional engagement module;
a plurality of video cameras in communication with the server,
said server comprising at least a processor in communication with a memory, said memory comprising computer readable instructions that when executed by the processor cause the processor to:
track, using a first of the plurality of the video cameras, key facial points of one or more students and using the tracked key facial points of the one or more students extracting a head pose for each of the one or more students;
track, using a second of the plurality of video cameras, eye gaze of each of the one or more students,
wherein the head pose and the eye gaze of each of the one or more students is provided to the behavioral engagement module and the emotional engagement module, and
wherein the behavioral engagement module classifies an average behavioral engagement of the one or more students and/or a behavioral engagement of each of the one or more students, and
wherein the emotional engagement module classifies each students' emotional engagement into two categories, emotionally engaged or emotionally non-engaged.

2. The system of claim 1, further comprising a display in communication with the server, wherein the display displays a web-based dashboard, wherein the web-based dashboard allows an instructor to monitor a real-time average class engagement level or individual engagement levels using the classified average behavioral engagement of the one or more students and/or a behavioral engagement of each of the one or more students, and the classified emotional engagement of each of the one or more students.

3. The system of claim 1, wherein tracking key facial points and using them to extract the head pose comprises the processor using a convolutional experts-constrained local model (CE-CLM), which uses a 3D representation of facial landmarks and projects them on the image using orthographic camera projection providing accurate estimation of the head pose once the facial landmarks are detected, wherein head pose is represented in six degrees of freedom (DOF) (three degrees of freedom of head rotation (R)—yaw, pitch, and roll—and 3 degrees of translation (T)—X, Y, and Z).

4. The system of claim 1, wherein tracking eye gaze comprises the processor measuring either a point of gaze or a motion of an eye relative to a head, wherein eye gaze is represented as a vector from a 3-Dimensional eyeball's center to a pupil of the eye, wherein eyelids, iris, and pupil are of the one or more students are detected and are used to compute an eye gaze vector for each eye.

5. The system of claim 4, wherein a vector from the camera origin to the center of the pupil in the image plane is drawn, and its intersection with the eye-ball sphere is calculated to get the 3D pupil location in world coordinates.

6. The system of claim 1, wherein the first of the plurality of the video cameras comprises one or more wall-mounted video cameras that provide the head pose only of the one or more students, and wherein the second of the plurality of cameras comprise one or more student cameras that provide both head poses and eye gazes for each of the one or more students, wherein coordinates of each of the plurality of cameras are aligned to get all of the one or more students' head poses and eye gazes in a common world-coordinate system.

7. The system of claim 6, wherein target planes are found through a one-time pre-calibration for a class comprised of the one or more students.

8. The system of claim 7, wherein intersections of each of the one or more students' head pose/eye gaze rays and the target planes are calculated.

9. The system of claim 8, wherein to eliminate noise, the calculation of the intersections of each of the one or more students' head pose/eye gaze rays and the target planes is combined within a window of time of size T, and a mean point of gaze can be found on each target plane in addition to a standard deviation for each window of time.

10. The system of claim 9, wherein a plane of interest in each window of time is the target plane with a least standard deviation of the students' gaze.

11. The system of claim 10, further comprising calculation for each of the one or more students, a student's pose/gaze index.

12. The system of claim 11, wherein each students pose/gaze index is calculated as a deviation of student's gaze points from the mean gaze point in each window of time.

13. The system of claim 12, wherein each students pose/gaze index is used to classify the average behavioral engagement of the one or more students within a window of time.

14. The system of claim 1, wherein to measure emotional engagement of each of the one or more students, the emotional engagement module uses extracted faces to extract 68 facial feature points using a well-trained artificial intelligence (AI) model, wherein the well-trained AI model allows estimation of a students' engagement even if their faces are not front-facing.

15. The system of claim 14, wherein the emotional engagement module uses a method for action-unit detection under pose variation using the detected facial points to extract 22 most significant patches to be used for the action-unit detection.

16. The system of claim 15, wherein the emotional engagement module uses a deep region-based neural network architecture in a multi-label setting to learn both the required features and the semantic relationships of Aus and a weighted loss function is used to overcome an imbalance problem in multi-label learning.

17. The system of claim 16, wherein the extracted facial action units are used to estimate affective states (boredom, confusion, delight, frustration, and neutral) by correlations.

18. The system of claim 17, wherein the estimated affective states determines the extent to which each of the facial features is used to feed a support vector machine (SVM) to classify the students' emotional engagement into the two categories, emotionally engaged or emotionally non-engaged.

19. A method of measuring student engagement using facial expression analysis, said method comprising:
providing a system, said system comprising:
a server, said server comprising at least a behavioral engagement module and an emotional engagement module;
a plurality of video cameras in communication with the server,
said server comprising at least a processor in communication with a memory, said memory comprising computer readable instructions that are executed by the processor;
track, using a first of the plurality of the video cameras, key facial points of one or more students and using the tracked key facial points of the one or more students extracting a head pose for each of the one or more students;
track, using a second of the plurality of video cameras, eye gaze of each of the one or more students,
wherein the head pose and the eye gaze of each of the one or more students is provided to the behavioral engagement module and the emotional engagement module, and
wherein the behavioral engagement module classifies an average behavioral engagement of the one or more students and/or a behavioral engagement of each of the one or more students, and
wherein the emotional engagement module classifies each students' emotional engagement into two categories, emotionally engaged or emotionally non-engaged.

20. A non-transitory computer-program product for measuring student engagement using facial expression analysis comprising computer-executable code sections stored on a non-transitory computer-readable medium that when executed by a processor cause the processor to:
track, using a first of the plurality of the video cameras, key facial points of one or more students and using the tracked key facial points of the one or more students extracting a head pose for each of the one or more students;
track, using a second of the plurality of video cameras, eye gaze of each of the one or more students,
provide the head pose and the eye gaze of each of the one or more students to a behavioral engagement module and an emotional engagement module of a server, and
classify, using the behavioral engagement module, an average behavioral engagement of the one or more students and/or a behavioral engagement of each of the one or more students, and
classify, using the emotional engagement module, each students' emotional engagement into two categories, emotionally engaged or emotionally non-engaged.
